(19) United States
(12) Patent Application Publication
(10) Pub. No.: US 2026/0254554 A1
(43) Pub. Date: Aug. 27, 2026

(54) TRANSMISSION USING MULTIPLE MODULATION AND CODING SCHEME VALUES

(71) Applicant: Lenovo (United States) Inc., Morrisville, NC (US)

(72) Inventors: Alexander Golitschek Edler von Elbwart, Darmstadt (DE); Joachim Löhr, Wiesbaden (DE)

(73) Assignee: Lenovo (United States) Inc., Morrisville, NC (US)

(21) Appl. No.: 19/060,461

(22) Filed: Feb. 21, 2025

(51) Int. Cl. H04L 1/00; H04W 72/0453; H04W 72/231; H04W 76/20

(52) U.S. Cl. CPC H04L 1/0003; H04W 72/0453; H04W 72/231; H04W 76/20

(57) ABSTRACT

Various aspects of the present disclosure relate to transmission using multiple modulation and coding scheme (MCS) values. A user equipment (UE) may receive signaling from a network equipment (NE) that indicates a set of MCS values associated with respective sets of frequency resources allocated for a transport block (TB). The signaling may include downlink control information (DCI) that allocates one or more time-frequency resources for a transmission (e.g., the TB). For example, the signaling indicates multiple MCS values for a TB. The UE obtains a size of the TB based on the set of MCS values and the respective sets of frequency resources. The UE map one or more code blocks (CBs) to the respective sets of frequency resources for transmission or reception of the TB based at least in part on the size of the TB.

### TECHNICAL FIELD

The present disclosure relates to wireless communications, and more specifically to transmitting and/or receiving signaling according to configured transmission parameters.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive signaling that indicates a set of modulation and coding scheme (MCS) values associated with respective sets of frequency resources allocated for a transport block (TB), obtain a size of the TB based on the set of MCS values and the respective sets of frequency resources, and map one or more code blocks (CBs) to the respective sets of frequency resources for transmission or reception of the TB based on the size of the TB.

A processor (e.g., a standalone processor chipset, or a component of a UE) for wireless communication is described. The processor may be configured to, capable of, or operable to perform one or more operations as described herein. For example, the processor may be configured to, capable of, or operable to receive signaling that indicates a set of MCS values associated with respective sets of frequency resources allocated for a TB, obtain a size of the TB based on the set of MCS values and the respective sets of frequency resources, and map one or more CBs to the respective sets of frequency resources for transmission or reception of the TB based on the size of the TB.

A method performed or performable by a UE for wireless communication is described. The method may include receiving signaling that indicates a set of MCS values associated with respective sets of frequency resources allocated for a TB, obtaining a size of the TB based on the set of MCS values and the respective sets of frequency resources, and mapping one or more CBs to the respective sets of frequency resources for transmission or reception of the TB based on the size of the TB.

In some implementations of the UE, the processor, and the method described herein, the UE, the processor, and the method may further be configured to, capable of, or operable to obtain an aggregate of a set of partial sizes of the TB, where each partial size of the set of partial sizes is based on a respective MCS value of the set of MCS values and the respective sets of frequency resources, and select the size of the TB based on the aggregate of the set of partial sizes of the TB. In some implementations of the UE, the processor, and the method described herein, the UE, the processor, and the method may further be configured to, capable of, or operable to select the size of the TB from a list based on a minimum MCS value of the set of MCS values. In some implementations of the UE, the processor, and the method described herein, the UE, the processor, and the method may further be configured to, capable of, or operable to assign respective CBs of the one or more CBs to code block groups (CBGs), where the respective CBs in a CBG of the CBGs are associated with a same MCS value of the set of MCS values.

In some implementations of the UE, the processor, and the method described herein, the signaling includes downlink control information (DCI) that indicates the respective sets of frequency resources allocated for the TB. In some implementations of the UE, the processor, and the method described herein, the respective sets of frequency resources include respective resource block (RB) ranges, and where one or more RBs in the respective RB ranges are non-overlapping. In some implementations of the UE, the processor, and the method described herein, the UE, the processor, and the method may further be configured to, capable of, or operable to receive radio resource control (RRC) signaling that indicates a set of RB ranges including the respective RB ranges and that indicates the respective RB ranges are associated with the set of MCS values. In some implementations of the UE, the processor, and the method described herein, the signaling includes indices corresponding to initial RBs in the respective RB ranges and a numerical quantity of consecutive RBs in the respective RB ranges. In some implementations of the UE, the processor, and the method described herein, the UE, the processor, and the method may further be configured to, capable of, or operable to transmit or receive, based on mapping the one or more CBs to the respective sets of frequency resources, coded bits of a CBG using the respective sets of frequency resources and corresponding respective MCS values of the set of MCS values.

An NE (e.g., a base station) for wireless communication is described. The NE may be configured to, capable of, or operable to perform one or more operations as described herein. For example, the NE may be configured to, capable of, or operable to transmit signaling that indicates a set of MCS values associated with respective sets of frequency resources allocated for a TB, where a size of the TB is based on the set of MCS values and the respective sets of frequency resources, and transmit or receive, on the respective sets of frequency resources, one or more CBs of the TB based on the size of the TB.

A processor (e.g., a standalone processor chipset, or a component of a NE) for wireless communication is described. The processor may be configured to, capable of, or operable to perform one or more operations as described herein. For example, the processor may be configured to, capable of, or operable to transmit signaling that indicates a set of MCS values associated with respective sets of frequency resources allocated for a TB, where a size of the TB is based on the set of MCS values and the respective sets of frequency resources, and transmit or receive, on the respective sets of frequency resources, one or more CBs of the TB based on the size of the TB.

A method performed or performable by an NE for wireless communication is described. The method may include transmitting signaling that indicates a set of MCS values associated with respective sets of frequency resources allocated for a TB, where a size of the TB is based on the set of MCS values and the respective sets of frequency resources, and transmitting or receiving, on the respective sets of frequency resources, one or more CBs of the TB based on the size of the TB.

In some implementations of the NE, the processor, and the method described herein, the NE, the processor, and the method may further be configured to, capable of, or operable to transmit or receive respective CBs of the one or more CBs in CBGs, where the respective CBs in a CBG of the CBGs are associated with a same MCS value of the set of MCS values. In some implementations of the NE, the processor, and the method described herein, the signaling includes DCI that indicates the respective sets of frequency resources allocated for the TB. In some implementations of the NE, the processor, and the method described herein, the respective sets of frequency resources include respective RB ranges, and where one or more RBs in the respective RB ranges are non-overlapping. In some implementations of the NE, the processor, and the method described herein, the NE, the processor, and the method may further be configured to, capable of, or operable to transmit RRC signaling that indicates a set of RB ranges including the respective RB ranges and that indicates the respective RB ranges are associated with the set of MCS values. In some implementations of the NE, the processor, and the method described herein, the signaling includes indices corresponding to initial RBs in the respective RB ranges and a numerical quantity of consecutive RBs in the respective RB ranges. In some implementations of the NE, the processor, and the method described herein, the NE, the processor, and the method may further be configured to, capable of, or operable to transmit or receive coded bits of a CBG using the respective sets of frequency resources and corresponding respective MCS values of the set of MCS values.

### BRIEF DESCRIPTION OF THE DRAWINGS

FIGS. 1 and 2 illustrate examples of wireless communications systems in accordance with aspects of the present disclosure.

FIG. 3 illustrates an example transmission diagram, in accordance with aspects of the present disclosure.

FIGS. 4 and 5 illustrate example signaling diagrams, in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of an NE in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

### DETAILED DESCRIPTION

A wireless communications system may include one or more devices, such as UEs and NEs, that transmit and receive signaling. In some cases, the UE and the NE may support transmission and/or reception of a transport blocks (TB) (e.g., unit of data) using one or more allocated time-frequency resources. The time-frequency resources may include a set of resource blocks (RBs) in the frequency domain and one or more transmission time intervals in the time domain. In some examples, a signal quality may vary across the frequency resources. The NE and/or the UE may configure one or more parameters for the signaling at a TB granularity, such that the parameters for the transmission or reception are the same across the TB. For example, the NE and/or the UE may set a MCS value for a TB, where the MCS value defines the combination of modulation order and coding rate used for transmitting data. Higher MCS values may indicate higher-order modulation (e.g., 64-quadrature amplitude modulation (QAM), or 256-QAM) and/or less robust coding rates, providing for increased data throughput. Lower MCS values may indicate lower-order modulation (e.g., quadrature phase shift keying (QPSK), or 16-QAM) and more robust coding rates, which increases error protection but reduce data rates. Thus, to maintain a threshold signal quality across for transmission of the TB, the NE and/or the UE may set the parameters to account for a minimum signal quality across the frequency resources (e.g., a lower MCS). However, setting parameters to account for a minimum signal quality leads to inefficient use of time-frequency resources, as portions of the frequency resources with higher signal quality are underutilized.

As described herein, to improve efficiency related to use of time-frequency resources for a transmission, a NE may configure multiple MCS values for the transmission (e.g., a TB). For example, the NE may transmit a signaling that indicates the MCS values and corresponding sets of frequency resources allocated for the TB. The frequency resources may include RB ranges, which the NE may configure in RRC signaling prior to the resource assignment. The UE may transmit or receive the transmission by applying the MCS values according to the sets of frequency resources, such that the UE and/or the NE may use different MCS values to transmit and/or receive the transmission across different RB ranges allocated for the transmission. For example, the UE may obtain a size of the TB using the MCS values and corresponding sets of frequency resources. The UE may map CBs to the frequency resources for transmission or reception of the TB using the size of the TB. By utilizing multiple MCS values across frequency resources allocated for a transmission (e.g., a TB), a NE and/or a UE may improve spectral efficiency and increase data throughput. For example, the NE and/or the UE may increase available bandwidth by adapting the MCS value to varying channel conditions within a transmission.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

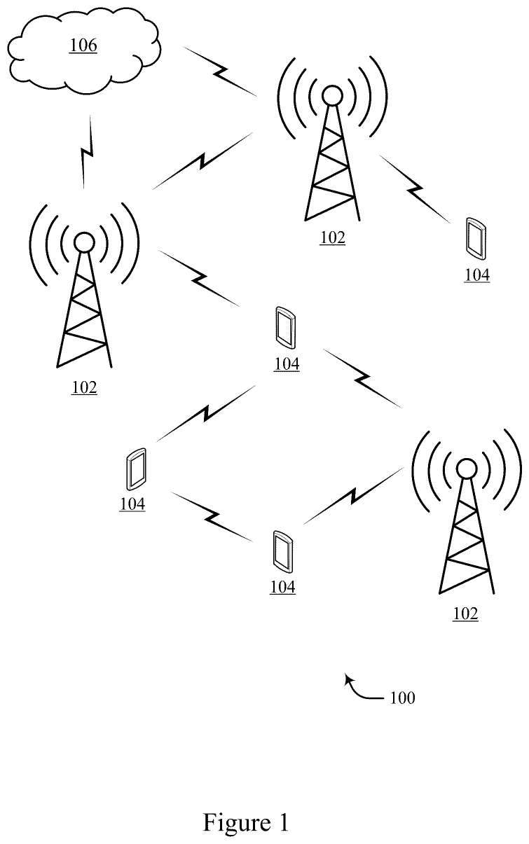

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 Megahertz (MHz)-7.125 GHz), FR2 (24.25 GHz-52.6 GHZ), FR3 (7.125 GHZ-24.25 GHZ), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

A transmission to a UE 104 from a NE 102 may be referred to as a transmission in a downlink direction or a downlink transmission. A transmission to a NE 102 from a UE 104 may be referred to as a transmission in an uplink direction or an uplink transmission. The transmission may include data, such as one or more data packets, and/or control information, such as one or more parameters or resources for a transmission. In some examples, a NE 102 may allocate (e.g., schedule, assign) one or more resources for an uplink transmission and/or a downlink transmission by transmitting control signaling (e.g., DCI) to a UE 104. For example, the NE 102 may transmit a frequency resource assignment that includes resources for the downlink transmission and/or the uplink transmission. In some examples, an uplink and downlink resource assignment supports a single MCS value assignment applicable to assigned RBs.

An MCS value may refer to a configurable parameter that specifies both a modulation order and a coding rate for a transmission. The MCS value may indicate for the UE 104 and/or the NE 102 to encode and modulate the transmission to account for data throughput and error protection. For downlink transmissions, a NE 102 may select an MCS value based on channel conditions reported by a UE 104. The NE 102 may then use the MCS value to encode and modulate data before transmission to the UE 104. For channel conditions that enable higher data rates or more robust transmission, the NE 102 may select (e.g., choose, determine) a higher MCS value to implement a higher-order modulation scheme, such as 256-QAM, and a less robust coding rate to increase data throughput. For channel conditions that lead to lower data rates or less robust transmission, the NE 102 may select (e.g., choose, determine) a lower MCS value to implement a lower-order modulation scheme and a more robust coding rate to increase error protection. Additionally, or alternatively, for uplink transmissions, a UE 104 may receive an MCS value assignment from the NE 102 via control signaling (e.g., DCI). The UE 104 may apply the assigned MCS value to encode and modulate an uplink data transmission.

The NE may transmit the frequency resource assignment in DCI with a defined format with respective bits and/or fields that configure the MCS value. For a DCI Format 0_0, a DCI Format 0_2, a DCI Format 1_0, a DCI Format 1_2, a DCI Format 4_0, and a DCI Format 4_1, the MCS value may include 5 bits. For a DCI Format 0_1, a DCI Format 1_1, and a DCI Format 4_2, the MCS value may include 5 bits for a first TB and 5 bits for a second TB. A DCI Format 0 3 and a DCI format 1_3 may be used for scheduling an uplink shared channel (e.g., a physical uplink shared channel (PUSCH) in a cell or multiple uplink shared channels in multiple cells with one uplink shared channel per cell. The MCS value in the DCI Format 0_3 and the DCI Format 1_3 may be determined according to a block number, including block number 1, block number 2, . . . , block number N_{cell}^{UL}. Each block includes 5 bits and corresponds to the MCS value for a cell, and the blocks are placed according to an ascending order of a serving cell index, with block number 1 corresponding to the MCS for the cell with a smallest serving cell index. For the DCI Format 1_3, the bits for an MCS value for a first TB and a second TB are determined by the block number. The DCI Format 0_3 and the DCI Format 1_3 may include multiple MCS fields, where each MCS field is applicable to a cell, and therefore to a single TB (e.g. the same MCS is applied to a TB).

In some examples, a NE 102 and/or a UE 104 may support two downlink resource allocation schemes, type 0 and type 1. The UE 104 may determine that when the scheduling grant is received with the DCI Format 1_0, the DCI Format 4_0, or the DCI Format 4_1, then downlink resource allocation type 1 is used. If the scheduling DCI is configured to indicate the downlink resource allocation type as part of the a frequency domain resource assignment field by setting a higher layer parameter resourceAllocation in a downlink shared channel (e.g., physical downlink shared channel (PDSCH)) configuration, such as PDSCH-Config, to a value, dynamicSwitch, for DCI Format 1_1 or setting a higher layer parameter resourceAllocationDCI-1-2 in PDSCH-Config to a value, dynamicSwitch, for DCI Format 1_2 or setting a higher layer parameter resourceAllocationDCI-1-3 in PDSCH-ConfigDCI-1-3 to a value, dynamicSwitch, for DCI Format 1_3 or setting a higher layer parameter resourceAllocation in pdsch-ConfigMulticast to a value, dynamicSwitch, for DCI Format 4_2, the UE 104 may use downlink resource allocation type 0 or type 1 as defined by the DCI field. Additionally, or alternatively, the UE 104 may use the downlink frequency resource allocation type as defined by a higher layer parameter resource Allocation in PDSCH-Config for DCI Format 1_1 or by the higher layer parameter resource AllocationDCI-1-2 for DCI Format 1_2 or by the higher layer parameter resourceAllocationDCI-1-3 for DCI Format 1_3 or by the higher layer parameter resourceAllocation in pdsch-ConfigMulticast for DCI Format 4 2.

If a bandwidth part (BWP) indicator field is not configured in the scheduling DCI or the UE 104 does not support active BWP change via DCI, then the RB indexing for downlink type 0 and type 1 resource allocation is determined within an active BWP of the UE 104. If a BWP indicator field is configured in the scheduling DCI and the UE 104 supports active BWP change via DCI, then the RB indexing for downlink type 0 and type 1 resource allocation is determined within the BWP of the UE 104 indicated by BWP indicator field value in the DCI. The UE 104 may, upon detection of a downlink control channel (e.g., a physical downlink control channel (PDCCH)) intended for the UE 104, determine first the downlink BWP and then the resource allocation within the BWP. For a PDSCH scheduled with a DCI Format 1_0 in any type of PDCCH common search space, regardless of which BWP is the active BWP, RB numbering starts from the lowest RB of the control resource set (CORESET) in which the DCI was received. Additionally, or alternatively, RB numbering starts from the lowest RB in the determined downlink BWP. If the PDCCH reception includes two PDCCH candidates from two respective search space sets, then for the purpose of determining the downlink RB set of a PDSCH when scheduled by DCI Format 1_0, the CORESET with a lower identifier among two CORESETs associated with two PDCCH candidates is used.

For downlink resource allocation of type 0, the RB assignment information includes a bitmap indicating the RB groups (RBGs) that are allocated to the scheduled UE 104, where a RBG is a set of consecutive virtual RBs defined by a higher layer parameter rbg-Size configured by PDSCH-Config for DCI Format 1_1 or DCI Format 1_2 or by higher layer parameter rbg-SizeDCI-1-3 configured by PDSCH-ConfigDCI-1-3 for DCI Format 1_3 and the size of the BWP as defined in Table 1.

TABLE 1
Nominal RBG size P

| BWP Size | Configuration 1 | Configuration 2 | Configuration 3 |
|---|---|---|---|
| 1-36 | 2 | 4 | 8 |
| 37-72 | 4 | 8 | 16 |
| 73-144 | 8 | 16 | 32 |
| 145-275 | 16 | 16 | 32 |

A total number of RBGs (N_{RBG}) for a downlink BWP i of size

$${N}_{B WP , i}^{s i z e}$$

PRBs is given by Equation 1:

$${N}_{R B G} = ⌈ ( {N}_{BWP , i}^{s i z e} + ( {N}_{B WP , i}^{start} mod P ) ) / P ⌉ , \qquad ( 1 )$$

where the size of the first RBG is

$$R B {G}_{0}^{s i z e} = P - {N}_{BWP , i}^{start} mod P ,$$

the size of last RBG is

$$R B {G}_{last}^{s i z e} = ( {N}_{B WP , i}^{start} + {N}_{BWP , i}^{s i z e} ) mod P if ( {N}_{B WP , i}^{start} + {N}_{BWP , i}^{s i z e} ) mod P > 0$$

and P otherwise, the size of all other RBGs is P.

For downlink resource allocation of type 0 scheduled using a DCI with cyclic redundancy check (CRC) bits scrambled by a group-radio network temporary identifier (G-RNTI) for multicast or group-configured scheduling-radio network temporary identifier (G-CS-RNTI), the RB assignment information bitmap is calculated based on the description above with the following changes the parameter

$${N}_{BWP , i}^{start}$$

is the starting PRB of the CFR,

$${N}_{BWP , i}^{s i z e}$$

is the size of the common frequency resource (CFR) and the value of the higher layer parameter rbg-Size is configured by pdsch-ConfigMulticast. In some cases, the bitmap is of size N_{RBG} bits with one bitmap bit per RBG such that each RBG is addressable. The RBGs may be indexed in the order of increasing frequency and starting at the lowest frequency of the BWP. The order of RBG bitmap is such that RBG 0 to RBG, N_{RBG}−1, are mapped from most significant bit (MSB) to least significant bit (LSB). The RBG is allocated to the UE 104 if the corresponding bit value in the bitmap is 1, the RBG is not allocated to the UE 104 otherwise.

For downlink resource allocation of type 1, the RB assignment information indicates to a scheduled UE 104 a set of contiguously allocated non-interleaved or interleaved virtual RBs within the active BWP of size

$${N}_{BWP}^{s i z e}$$

PRBs except for the case when DCI Format 1_0 is decoded in any common search space in which case the size of CORESET 0 may be used if CORESET 0 is configured for the cell and the size of initial DL BWP may be used if CORESET 0 is not configured for the cell. A downlink type 1 resource allocation field consists of a resource indication value (RIV) corresponding to a starting virtual RB (RBₛₜₐᵣₜ) and a length in terms of contiguously allocated RBs, L_{RBs}. The RIV is defined by if

$$( {L}_{RBs} - 1 ) \leq ⌊ {N}_{BWP}^{s i z e} / 2 ⌋ then RIV = {N}_{BWP}^{s i z e} + ( {L}_{RBs} - 1 ) + {RB}_{start} , \\ else RIV = {N}_{BWP}^{s i z e} ( {N}_{BWP}^{s i z e} - {L}_{R B s} + 1 ) + ( {N}_{BWP}^{s i z e} - 1 - R {B}_{start} ) ,$$

where L_{RBs}≥1 and may not exceed

$${N}_{BWP}^{s i z e} - R {B}_{start} .$$

If the DCI size for DCI Format 1_0 in a UE-specific search space is derived from the size of DCI Format 1_0 in cell-specific search space, but applied to an active BWP with size of

$${N}_{BWP}^{active} ,$$

a downlink type 1 RB assignment field consists of a RIV corresponding to a starting RB

$$R {B}_{start} = 0 , K , 2 \cdot K , … , ( {N}_{BWP}^{initial} - 1 ) \cdot K$$

and a length in terms of virtually contiguously allocated RBs

$${L}_{R B s} = K , 2 \cdot K , … , {N}_{BWP}^{initial} \cdot K , where {N}_{BWP}^{initial}$$

is given by the size of CORESET 0 if CORESET 0 is configured for the cell or the size of initial DL BWP if CORESET 0 is not configured for the cell. The RIV is defined by if

$$( {L}_{RBs}^{′} - 1 ) \leq ⌊ {N}_{BWP}^{initial} / 2 ⌋ ,$$

$$then RIV = {N}_{BWP}^{initial} ( {L}_{RBs}^{′} - 1 ) + {RB}_{start}^{′} ,$$

$$else RIV = {N}_{BWP}^{initial} ( {N}_{BWP}^{initial} - {L}_{RBs}^{′} + 1 ) + ( {N}_{BWP}^{initial} - 1 - {RB}_{start}^{′} ) ,$$

$$where {L}_{RBs}^{′} = \frac{{L}_{RBs}}{K} ,$$

and where L′_{RBs} may not exceed

$${N}_{BWP}^{initial} - {RB}_{start}^{′} . If {N}_{BWP}^{active} > {N}_{BWP}^{initial} ,$$

K is the maximum value from set {1, 2, 4, 8} which satisfies

$$K \leq ⌊ {N}_{BWP}^{active} / {N}_{BWP}^{initial} ⌋ ,$$

otherwise K=1. If the scheduling grant is received with DCI Format 1_2 or DCI Format 13, then a downlink type 1 resource allocation field consists of a RIV corresponding to a starting RB group RBGstart=0, 1, . . . , NRBG−1 and a length in terms of virtually contiguously allocated RB groups LRBGs=1, . . . , NRBG, where the RB groups are defined with P defined by resourceAllocationTypeIGranularityDCI-1-2 for DCI Format 1_2 and resourceAllocationTypeIGranularityDCI-1-3 for DCI Format 1_3 if the UE 104 is configured with higher layer parameter resourceAllocationTypeIGranularityDCI-1-2 or resourceAllocationTypeIGranularityDCI-1-3, and P=1 otherwise. The RIV is defined by if (L_{RBGs}−1)<└N_{RBG}/2┘, then RIV=N_{RBG}(L_{RBGs}−1)+RBGₛₜₐᵣₜ, else RIV=N_{RBG}(N_{RBG}−L_{RBGs}+1)+(N_{RBG}−1−RBGₛₜₐᵣₜ), where L_{RBGs}≥1 and may not exceed N_{RBG}−RBGₛₜₐᵣₜ.

For downlink resource allocation of type 1 scheduled using DCI Format 4_0 or DCI Format 4_1 with CRC scrambled by G-RNTI, G-CS-RNTI, multicast control channel-radio network temporary identifier (MCCH-RNTI), or multicast MCCH-RNTI, the RB assignment information indicates to a scheduled UE 104 a set of contiguously allocated non-interleaved or interleaved virtual RBs. A downlink type 1 RB assignment field in the DCI format 4_0 or DCI format 4_1 consists of a RIV corresponding to a starting RB in reference to the lowest RB of the CFR

$${RB}_{start} = 0 , K , 2 \cdot K , … , ( {N}_{BWP}^{initial} - 1 ) \cdot K$$

and a length in terms of virtually contiguously allocated RBs LRBs, where

$${N}_{BWP}^{initial}$$

is given by the size of CORESET 0 if CORESET 0 is configured for the cell or the size of initial DL BWP if CORESET 0 is not configured for the cell. The RIV is defined by if

$$( {L}_{RBs}^{′} - 1 ) \leq ⌊ {N}_{BWP}^{initial} / 2 ⌋ ,$$

$$then RIV = {N}_{BWP}^{initial} ( {L}_{RBs}^{′} - 1 ) + {RB}_{start}^{′} ,$$

$$else RIV = {N}_{BWP}^{initial} ( {N}_{BWP}^{initial} - {L}_{RBs}^{′} + 1 ) + ( {N}_{BWP}^{initial} - 1 - {RB}_{start}^{′} ) ,$$

$$where {L}_{RBs}^{′} = \frac{{L}_{RBs}}{K} , {RB}_{start}^{′} = \frac{{RB}_{start}}{K}$$

and where L′_{RBs} may not exceed

$${N}_{BWP}^{initial} - {RB}_{start}^{′} . If {N}_{CFR} > {N}_{BWP}^{initial} ,$$

K is the maximum value from set {1, 2, 4, 6, 8, 10, 12} which satisfies

$$K \leq ⌊ {N}_{CFR} / {N}_{BWP}^{initial} ⌋ ,$$

otherwise K=1. For downlink resource allocation of type 1 scheduled using DCI format 4_2 with CRC scrambled by G-RNTI for multicast or G-CS-RNTI, RBₛₜₐᵣₜ corresponds to a starting RB in reference to the lowest RB of the CFR and

$${N}_{BWP}^{size}$$

is the size of the CFR.

In some examples, the NE 102 may perform DL physical RB (PRB) bundling, in which multiple adjacent PRBs are grouped together and treated as a single unit for resource allocation and scheduling purposes. The size of the PRB bundle may be configurable based on system bandwidth, channel conditions, and the criterion of the transmission. The PRB bundling procedures for PDSCH scheduled by PDCCH with DCI Format 1_1 apply to PDSCH scheduled by PDCCH with DCI Format 1_2, by applying the parameters of prb-BundlingTypeDCI-1-2 instead of prb-BundlingType as well as vrb-ToPRB-InterleaverDCI-1-2 instead of vrb-ToPRB-Interleaver. The PRB bundling procedures for PDSCH scheduled by PDCCH with DCI Format 1_1 also apply to PDSCH scheduled by PDCCH with DCI Format 1_3. The PRB bundling procedures for PDSCH scheduled by PDCCH with DCI Format 1_1 also apply to PDSCH scheduled by PDCCH with DCI Format 4_2, by applying the parameters of prb-BundlingType given by pdsch-ConfigMulticast as well as vrb-ToPRB-Interleaver given by pdsch-ConfigMulticast.

A UE 104 may determine that precoding granularity is

$${P}_{BWP , i}^{′}$$

consecutive RBs in the frequency domain.

$${P}_{BWP , i}^{′}$$

can be equal to one of the values among {2, 4, wideband} in a 5G NR system, but might be equal to additional or other values in other systems or evolved releases. If

$${P}_{BWP , i}^{′}$$

is determined as wideband, then the UE 104 is not expected to be scheduled with non-contiguous PRBs and the UE 104 may determine that the same precoding is applied to the allocated resource associated with a same TCI state or a same QCL assumption. If

$${P}_{BWP , i}^{′}$$

is determined as one of the values among {2, 4}, precoding RBGs (PRGs) partitions the BWP i with

$${P}_{BWP , i}^{′}$$

consecutive PRBs. An actual number of consecutive PRBs in each PRG could be one or more. The first PRG size is given by

$${P}_{BWP , i}^{′} - {N}_{BWP , i}^{start} mod {P}_{BWP , i}^{′}$$

and the last PRG size given by

$$( {N}_{BWP , i}^{start} + {N}_{BWP , i}^{size} ) mod {P}_{BWP , i}^{′} if ( {N}_{BWP , i}^{start} + {N}_{BWP , i}^{size} ) mod {P}_{BWP , i}^{′} \neq 0 ,$$

and the last PRG size is

$${P}_{BWP , i}^{′} if ( {N}_{BWP , i}^{start} + {N}_{BWP , i}^{size} ) mod {P}_{BWP , i}^{′} = 0.$$

For PDSCH scheduled by PDCCH with DCI scrambled using G-RNTI or G-CS-RNTI,

$${N}_{BWP , i}^{start}$$

is the starting PRB of the CFR and

$${N}_{BWP , i}^{size}$$

is the CFR. The UE 104 may determine the same precoding is applied for any downlink contiguous allocation of PRBs in a PRG.

For a PDSCH carrying a system information block (SIB) (e.g., SIB1) scheduled by PDCCH with CRC scrambled by a system information-radio network temporary identifier (SI-RNTI), a PRG is partitioned from the lowest numbered RB of CORESET 0 if the corresponding PDCCH is associated with CORESET 0 and Type0-PDCCH common search space and is addressed to SI-RNTI. Otherwise, a PRG is partitioned from common RB 0. If a UE 104 is scheduled a PDSCH with DCI Format 1_0 or DCI Format 4_0 for broadcast or DCI Format 4_1 for multicast, then the UE 104 may determine that

$${P}_{BWP , i}^{′}$$

is equal to 2 PRBs. When receiving PDSCH scheduled by PDCCH with DCI Format 1_1 with CRC scrambled by C-RNTI, MCS-C-RNTI, or CS-RNTI,

$${P}_{BWP , i}^{′}$$

for BWP is equal to 2 PRBs unless configured by the higher layer parameter prb-BundlingType given by PDSCH-Config. When receiving PDSCH scheduled by PDCCH with DCI Format 1_1 with CRC scrambled by C-RNTI, MCS-C-RNTI, or CS-RNTI, if the higher layer parameter prb-BundlingType is set to a value, dynamicBundling, then the higher layer parameters bundleSizeSet1 and bundleSizeSet2 configure two sets of

$${P}_{BWP , i}^{′}$$

values, the first set can take one or two

$${P}_{BWP , i}^{′}$$

values among {2, 4, wideband}, and the second set can take one

$${P}_{BWP , i}^{′}$$

value among {2, 4, wideband}.

If the PRB bundling size indicator field signaled in DCI Format 1_1 is set to a value of zero, then the UE 104 may use the

$${P}_{BWP , i}^{′}$$

value from the second set of

$${P}_{BWP , i}^{′}$$

values when receiving PDSCH scheduled by the same DCI. If PRB bundling size indicator field signaled in DCI Format 1_1 is set to a value of one and one value is configured for the first set of

$${P}_{BWP , i}^{′}$$

values, then the UE 104 may use this

$${P}_{BWP , i}^{′}$$

value when receiving PDSCH scheduled by the same DCI. If the PRB bundling size indicator field signaled in DCI Format 1_1 is set to a value of one and two values are configured for the first set of

$${P}_{BWP , i}^{′}$$

values as n2-wideband (e.g., corresponding to two

$${P}_{BWP , i}^{′}$$

values 2 and wideband) or n4-wideband (e.g., corresponding to two

$${P}_{BWP , i}^{′}$$

values 4 and wideband), then the UE 104 may use the value when receiving PDSCH scheduled by the same. If the scheduled PRBs are contiguous and the size of the scheduled PRBs is larger than

$${N}_{BWP , i}^{size} / 2 , {P}_{BSP , i}^{′}$$

is the same as the scheduled bandwidth, otherwise

$${P}_{BWP , i}^{′}$$

is set to the remaining configured value of 2 or 4, respectively.

When receiving PDSCH scheduled by PDCCH with DCI Format 1_1 with CRC scrambled by C-RNTI, MCS-C-RNTI, or CS-RNTI, if the higher layer parameter prb-BundlingType is set to a value, staticBundling, then the

$${P}_{BWP , i}^{′}$$

value is configured with the single value indicated by the higher layer parameter bundleSize. If a UE is configured with nominal RBG size P=2 for BWP I, or if a UE 104 is configured with interleaving unit of 2 for a virtual resource block (VRB) to PRB mapping provided by the higher layer parameter vrb-ToPRB-Interleaver given by PDSCH-Config for BWP i, then the UE 104 is not expected to be configured with

$${P}_{BWP , i}^{′} = 4.$$

For a UE configured by the higher layer parameter repetitionScheme set to a value, fdmSchemeA or fdmSchemeB, and if the UE 104 not configured with dl-OrJointTCI-StateList is indicated with two TCI states in a codepoint of the DCI field transmission configuration indication, or if the UE 104 is configured with dl-OrJointTCI-StateList and having two indicated TCI States to be applied to PDSCH, and the UE 104 is indicated with one or more demodulation reference signal (DMRS) ports within one code division multiplexing (CDM) group in the DCI field antenna ports, then the following may be true. If

$${P}_{BWP . i}^{′}$$

is determined as wideband, the first

$$⌈ \frac{{n}_{PRB}}{2} ⌉$$

PRBs are assigned to the first TCI state and the remaining

$$⌈ \frac{{n}_{PRB}}{2} ⌉$$

PRBs are assigned to the second TCI state, where n_{PRB} is the total number of allocated PRBs for the UE. If

$${P}_{BWP . i}^{′}$$

is determined as one of the values among {2, 4}, even PRGs within the allocated frequency domain resources are assigned to the first TCI state and odd PRGs within the allocated frequency domain resources are assigned to the second TCI state, wherein the PRGs are numbered continuously in increasing order with the first PRG index equal to 0. The UE 104 is not expected to receive more than two PDSCH transmission layers for each PDSCH transmission occasion.

For a UE configured by the higher layer parameter repetitionScheme set to a value fdmSchemeB, and if the UE 104 is not configured with dl-OrJointTCI-StateList is indicated with two TCI states in a codepoint of the DCI field transmission configuration indication, or if the UE 104 configured with d-OrJointTCI-StateList and having two indicated TCI States to be applied to PDSCH, and the UE 104 is indicated with one or more DMRS ports within one CDM group in the DCI field antenna ports, each PDSCH transmission occasion may be mapped to a transmission occasion, and the UE 104 may expect at most two CBs per PDSCH transmission occasion when a single transmission layer is scheduled and a single CB per PDSCH transmission occasion when two transmission layers are scheduled. For two PDSCH transmission occasions, the redundancy version to be applied is derived according to a defined list of redundancy versions, where n=0, 1 are applied to the first and second TCI state, respectively.

The UE 104 may determine the RB assignment in frequency domain using the resource allocation field in the detected PDCCH DCI except for a PUSCH transmission scheduled by a random access response (RAR) uplink grant or fallback RAR uplink grant, in which case the frequency domain resource allocation (FDRA) is configured or a MsgA PUSCH transmission with FDRA is configured. The NE 102 and/or the UE 104 may support three uplink resource allocation schemes, including type 0, type 1 and type 2. Uplink resource allocation scheme type 0 is supported for PUSCH when transform precoding is disabled. Uplink resource allocation scheme type 1 and type 2 are supported for PUSCH for both cases when transform precoding is enabled or disabled.

If the scheduling DCI is configured to indicate the uplink resource allocation type as part of the frequency domain resource assignment field by setting a higher layer parameter resourceAllocation in an uplink shared channel configuration (e.g., pusch-Config) to a value, dynamicSwitch, for DCI Format 0_1 or setting a higher layer parameter resourceAllocationDCI-0-2 in the pusch-Config to a value, dynamicSwitch, for DCI Format 0_2 or setting a higher layer parameter resourceAllocationDCI-0-3 in the pusch-ConfigDCI-0-3 to a value, dynamicSwitch, for DCI Format 0_3, then the UE 104 may use uplink resource allocation type 0 or type 1 as defined by the DCI field. Additionally, or alternatively, the UE 104 may use the uplink frequency resource allocation type as defined by the higher layer parameter resourceAllocation for DCI Format 0_1 or the higher layer parameter resourceAllocationDCI-0-2 for DCI format 0_2 or by the higher layer parameter resourceAllocationDCI-0-3 for DCI format 0_3. The UE 104 may determine that when the scheduling PDCCH is received with DCI Format 0_1 and/or DCI Format 0_3 and useInterlacePUCCH-PUSCH in BWP-UplinkDedicated is configured, uplink type 2 resource allocation is used.

The UE 104 may determine that when the scheduling PDCCH is received with DCI Format 0_0, then uplink resource allocation type 1 is used, except when any of the higher layer parameters useInterlacePUCCH-PUSCH in BWP-UpinkCommon and useInterlacePUCCH-PUSCH in BWP-UplinkDedicated is configured in which case uplink resource allocation type 2 is used. The UE 104 may determine that either none or both of useInterlacePUCCH-PUSCH in BWP-UplinkCommon and useInterlacePUCCH-PUSCH in BWP-UplinkDedicated is configured. If a BWP indicator field is not configured in the scheduling DCI or the UE 104 does not support active BWP change via DCI, then the RB indexing for uplink type 0, type 1 and type 2 resource allocation is determined within an active BWP of the UE 104. If a BWP indicator field is configured in the scheduling DCI and the UE 104 supports active BWP change via DCI, then the RB indexing for uplink type 0, type 1, type 2 resource allocation is determined within the BWP of the UE 104 indicated by BWP indicator field value in the DCI. The UE 104 may, upon detection of PDCCH intended for the UE 104, determine first the uplink BWP and then the resource allocation within the BWP. RB numbering starts from the lowest RB in the determined uplink BWP.

For uplink resource allocation of type 0, the RB assignment information includes a bitmap indicating the RBGs that are allocated to the scheduled UE 104, where a RBG is a set of consecutive virtual RBs defined by higher layer parameter rbg-Size for DCI Format 0_1 and/or DCI Format 0_2 configured in pusch-Config or rbg-SizeDCI-0-3 for DCI Format 0_3 configured in pusch-ConfigDCI-0-3. The size of the BWP is defined in Table 1. The total number of RBGs (N_{RBG}) for an uplink BWP i of size,

$${N}_{BWP , i}^{s i z e} ,$$

PRBs is given by Equation 1.

The bitmap is of size N_{RBG} bits with one bitmap bit per RBG such that each RBG is addressable. The RBGs may be indexed in the order of increasing frequency of the BWP and starting at the lowest frequency. The order of RBG bitmap is such that RBG 0 to RBG N_{RBG}−1 are mapped from MSB to LSB of the bitmap. The RBG is allocated to the UE 104 if the corresponding bit value in the bitmap is 1, the RBG is not allocated to the UE 104 otherwise. In frequency range 1 (FR1), non-contiguous allocation may be defined per component carrier for uplink RB allocation for cyclic prefix (CP)-OFDM. In frequency range 2 (FR2), non-contiguous allocation per component carrier for uplink RB allocation for CP-OFDM is not supported.

For uplink resource allocation of type 1, the RB assignment information indicates to a scheduled UE 104 a set of contiguously allocated non-interleaved virtual RBs within the active BWP of size

$${N}_{BWP}^{s i z e}$$

PRBs except for the case when DCI Format 0_0 is decoded in any common search space in which case the size of the initial UL BWP

$${N}_{BWP , 0}^{s i z e}$$

may be used. An uplink type 1 resource allocation field consists of a RIV corresponding to a starting virtual RB (RBₛₜₐᵣₜ) and a length in terms of contiguously allocated RBs, L_{RBs}. The RIV is defined by if

$$( {L}_{R B s} - 1 ) \leq ⌊ {N}_{BWP}^{s i z e} / 2 ⌋ , \\ then RIV = {N}_{BWP}^{s i z e} ( {L}_{RBs} - 1 ) + {RB}_{start} , else RIV = {N}_{BWP}^{s i z e} ( {N}_{BWP}^{s i z e} - {L}_{R B S} + 1 ) + {N}_{BWP}^{s i z e} ( {N}_{BWP}^{s i z e} - 1 - {RB}_{start} ) ,$$

where L_{RBs}≥1 and may not exceed

$${N}_{BWP}^{s i z e} - {RB}_{start} .$$

If the DCI size for DCI Format 0_0 in the UE-specific search space is derived from the initial uplink BWP with size,

$${N}_{BWP}^{initial} ,$$

but applied to another active BWP with size of

$${N}_{BWP}^{active} ,$$

an uplink type 1 RB assignment field consists of a RIV corresponding to a starting RB,

$$R {B}_{start} = 0 , K , 2 \cdot K , … , ( {N}_{BWP}^{initial} - 1 ) \cdot K$$

and a length in terms of virtually contiguously allocated RBs

$${L}_{R B s} = 0 , K , 2 \cdot K , … , {N}_{BWP}^{initial} \cdot K .$$

The RIV is defined by if

$$( {L}_{RBs}^{′} - 1 ) \leq ⌊ {N}_{BWP}^{initial} / 2 ⌋ ,$$

$$then RIV = {N}_{BWP}^{initial} ( {L}_{RBs}^{′} - 1 ) + {RB}_{start}^{′} ,$$

$$else RIV = {N}_{BWP}^{initial} ( {N}_{BWP}^{initial} - {L}_{RBs}^{′} + 1 ) + ( {N}_{BWP}^{initial} - 1 - {RB}_{start}^{′} ′ ) ,$$

$${whereL}_{RBs}^{′} = \frac{{L}_{R B s}}{K} , {RB}_{start}^{′} = \frac{{RB}_{start}}{K}$$

and where L′_{RBs} may not exceed

$${N}_{BWP}^{initial} - {RB}_{start}^{′} . If {N}_{BWP}^{active} > {N}_{BWP}^{initial} ,$$

K is the maximum value from set {1, 2, 4, 8} which satisfies

$$K \leq ⌊ {N}_{BWP}^{active} / {N}_{BWP}^{initial} ⌋ ,$$

otherwise K=1.

If the scheduling grant is received with DCI Format 0_2 or DCI Format 03, then an uplink type 1 resource allocation field consists of a RIV corresponding to a starting RB group RBGstart=0, 1, . . . , NRBG−1 and a length in terms of virtually contiguously allocated RB groups LRBGs=1, . . . , NRBG, where the RB groups are defined with P defined by resourceAllocationTypeIGranularityDCI-0-2 for DCI Format 0_2 and by resourceAllocationTypeIGranularityDCI-0-3 for DCI Format 0_3 if the UE 104 is configured with higher layer parameter resourceAllocationTypeIGranularityDCI-0-2 or resourceAllocationTypeIGranularityDCI-0-3, and P=1 otherwise. The RIV is defined by if (L_{RBGs}−1)≤└N_{RBG}/2┘, then RIV=N_{RBG}(L_{RBGs}−1)+RBGₛₜₐᵣₜ, else RIV=N_{RBG}(N_{RBG}−L_{RBGs}+1)+(N_{RBG}−1−RBGₛₜₐᵣₜ), where L_{RBGs}≥1 and may not exceed N_{RBG}−RBGₛₜₐᵣₜ.

For uplink resource allocation of type 2, the RB assignment information indicates to a UE 104 a set of up to M interlace indices, and for DCI format 0_0 monitored in a UE-specific search space and DCI Format 0_1 and DCI Format 0_3 a set of up to

$${N}_{R B - s et , UL}^{BWP}$$

contiguous RB sets, where M and interlace indexing are defined. Within the active UL BWP, the assigned physical RB n is mapped to virtual RB n. For DCI format 0_0 monitored in a UE-specific search space and DCI Format 0_1 and DCI Format 03, the UE 104 may determine the resource allocation in frequency domain as an intersection of the RBs of the indicated interlaces and the union of the indicated set of RB sets and intra-cell guard bands between the indicated RB sets, if any. For DCI Format 0_0 monitored in a common search space, the UE may determine the resource allocation in frequency domain as an intersection of the RBs of the indicated interlaces and a single uplink RB set of the active uplink BWP. For DCI Format 0_0 monitored in a CSS with CRC scrambled by a radio network temporary identifier (RNTI) other than temporary C-RNTI (TC-RNTI), the uplink RB set is the lowest indexed one amongst one or more uplink RB sets that intersects the lowest-indexed CCE of the PDCCH in which the UE 104 detects the DCI Format 0_0 in the active downlink BWP. If the PDCCH reception includes two PDCCH candidates from two respective search space sets, for the purpose of determining the uplink RB set of a PUSCH when scheduled by DCI Format 0_0 monitored in a CSS with CRC scrambled by an RNTI other than TC-RNTI, then the CORESET with lower identifier among two CORESETs associated with two PDCCH candidates is used. If there is no intersection, then the uplink RB set is RB set 0 in the active uplink BWP. For DCI format 0_0 with CRC scrambled by TC-RNTI, then the uplink RB set is the same one in which the UE 104 transmits the PRACH associated with the RAR uplink grant, in which case the UE 104 determines that the uplink RB set is defined as when the UE 104 is not configured with intraCellGuardBandsUL-List.

For μ=0, the X=6 MSBs of the RB assignment information indicates to a UE 104 a set of allocated interlace indices m₀+l, where the indication consists of a RIV. For 0≤RIV<M(M+1)/2, l=0, 1, . . . L−1 the RIV corresponds to the starting interlace index m0 and the number of contiguous interlace indices L (L≥1). The RIV is defined by if (L−1)≤└M/2┘ then RIV=M(L−1)+m₀ else RIV=M(M−L+1)+(M−1−m₀). For RIV≥M(M+1)/2, the RIV corresponds to the starting interlace index m0 and the set of values I according to Table 2.

TABLE 2
m0 and l for RIV ≥ M(M + 1)/2.

| RIV − M(M + 1)/2 | m0 | 1 |
|---|---|---|
| 0 | 0 | {0, 5} |
| 1 | 0 | {0, 1, 5, 6} |
| 2 | 1 | {0, 5} |
| 3 | 1 | {0, 1, 2, 3, 5, 6, 7, 8} |
| 4 | 2 | {0, 5} |
| 5 | 2 | {0, 1, 2, 5, 6, 7} |
| 6 | 3 | {0, 5} |
| 7 | 4 | {0, 5} |

For μ=1, the X=5 MSBs of the RB assignment information include a bitmap indicating the interlaces that are allocated to the scheduled UE 104. The bitmap is of size M bits with one bitmap bit per interlace such that each interlace is addressable, where M and interlace indexing is defined. The order of interlace bitmap is such that interlace 0 to interlace M−1 are mapped from MSB to LSB of the bitmap. An interlace is allocated to the UE 104 if the corresponding bit value in the bitmap is 1. Otherwise, the interlace is not allocated to the UE 104.

For DCI Format 0_0 monitored in a UE-specific search space and DCI formats 0_1 and 0_3 for both μ=0 and μ=1, the

$$Y = ⌈ {log}_{2} \frac{{N}_{RB - set , UL}^{BWP} ( {N}_{RB - set , UL}^{BWP} + 1 )}{2} ⌉$$

LSBs of the RB assignment information indicate to a UE 104 a set of contiguously allocated RB sets for PUSCH scheduled by DCI format 0_0 monitored in a UE-specific search space, DCI Format 0_1 and DCI Format 0_3 and Type 1 and Type 2 configured grant. The resource allocation field includes a RIV (RIV_{RB-set}). For

$$0 \leq {RIV}_{R B - s e t} < {N}_{RB - set , UL}^{BWP} ( {N}_{RB - set , UL}^{BWP} + 1 ) / 2 ,$$

l=0, 1, . . . L_{RBset}−1 the RIV corresponds to the starting RB set index

$${N}_{RB - set , UL}^{BWP}$$

and the number of contiguous RB sets L_{RB-set}. The RIV is defined by if

$$( {L}_{R B} - 1 ) \leq ⌊ {N}_{RB - set , UL}^{BWP} / 2 ⌋ ,$$

$$then {RIV}_{R B - s e t} = {N}_{RB - set , UL}^{BWP} ( {L}_{RB - set} - 1 ) + {N}_{RB - set , UL}^{BWP} ,$$

$$else {RIV}_{R B - s e t} = {N}_{RB - set , UL}^{BWP} ( {N}_{RB - set , UL}^{BWP} - {L}_{R B - s e t} + 1 ) + ( {N}_{RB - set , UL}^{BWP} - 1 - {N}_{RB - set , UL}^{BWP} ) ,$$

$$where {N}_{RB - set , UL}^{BWP} = 0 , 1 , … {N}_{RB - set , UL}^{BWP} - 1 , {L}_{R B - s e t} \geq 1$$

and may not exceed

$${N}_{RB - set , UL}^{BWP} - {N}_{RB - set , UL}^{start} .$$

If transform precoding is enabled, then the UE 104 transmits PUSCH on the lowest-indexed

$${M}_{R B}^{PUSCH}$$

PRBs amongst the PRBs indicated by the frequency domain resource assignment information.

$${M}_{R B}^{PUSCH}$$

is the largest integer not greater than the number of RBs indicated by the frequency domain resource assignment information that fulfils one or more defined conditions.

In some examples, the UE and the NE may support transmission and/or reception of a TB using one or more allocated time-frequency resources. A TB may refer to a unit of data that is processed and transmitted over a link in the wireless communications system 100. For example, a TB may represent a basic data structure used for transmitting information between a NE 102 and a UE 104. A TB may include data packets, control information, or both, and may be encoded, modulated, and mapped onto physical layer resources for transmission. RBs may represent frequency resources that can be allocated for data transmission in the physical layer. A TB may be mapped onto one or more RBs for transmission, depending on a size of the TB, referred to as a TB size (TBS), an available bandwidth, and an MCS value. A numerical quantity of RBs for transmitting a TB may vary based on the TBS and the spectral efficiency of the selected MCS.

In some examples, a signal quality may vary across the frequency resources (e.g., may be different for different RB ranges). The NE 102 and/or the UE 104 may configure one or more parameters for the signaling at a TB granularity, such that the parameters for the transmission or reception are the same across the TB. For example, the NE 102 and/or the UE 104 may set a MCS value for a TB. Thus, to maintain a threshold signal quality across for transmission of the TB, the NE 102 and/or the UE 104 may set the parameters to account for a minimum signal quality across the frequency resources (e.g., a lower MCS). However, setting parameters to account for a minimum signal quality leads to inefficient use of time-frequency resources, as portions of the frequency resources with higher signal quality are underutilized.

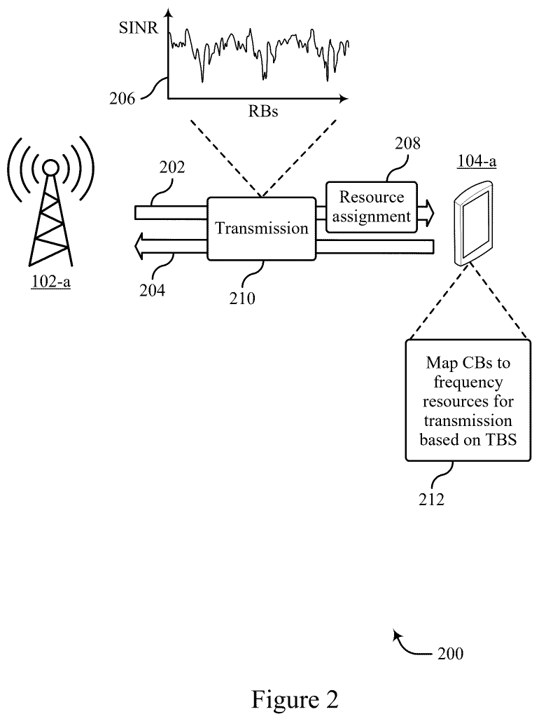

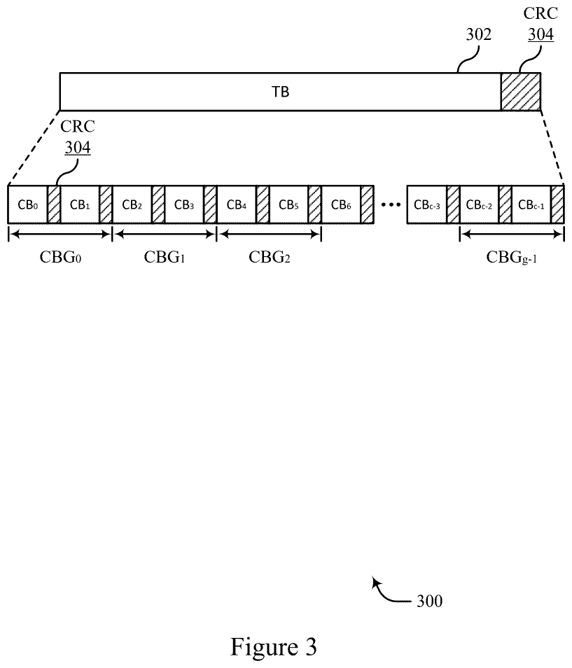

To improve efficiency related to use of time-frequency resources for a transmission, a NE 102 may configure multiple MCS values for the transmission (e.g., a TB). For example, the NE 102 may transmit a resource assignment or other signaling (e.g., DCI) that indicates the MCS values and corresponding sets of frequency resources allocated for the transmission. The frequency resources may include RB ranges, which the NE 102 may configure in RRC signaling prior to the resource assignment. The UE 104 may transmit or receive the transmission by applying the MCS values according to the sets of frequency resources, such that the UE 104 and/or the NE 102 may use different MCS values to transmit and/or receive the transmission across different RB ranges allocated for the transmission. For example, the UE 104 may determine (e.g., identify, obtain) a TBS using the MCS values and frequency resources, which is described in further detail with respect to FIG. 2. The UE 104 may map one or more CBs to frequency resources for transmission or reception of the TB using the TBS, which is described in further detail with respect to FIG. 3. By utilizing multiple MCS values across frequency resources allocated for a transmission (e.g., a TB), a NE 102 and/or a UE 104 may improve spectral efficiency and increase data throughput. For example, the NE 102 and/or the UE 104 may increase available bandwidth by adapting the MCS value to varying channel conditions within a transmission.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

FIG. 2 illustrates an example wireless communications system 200 in accordance with aspects of the present disclosure. In some examples, the wireless communications system 200 implements aspects of the wireless communications system 100. For example, the wireless communications system 200 includes a NE 102-a and a UE 104-a, which may be examples of a NE 102 and a UE 104 as described with reference to FIG. 1. In some examples, the UE 104-a and the NE 102-a may exchange signaling with one another. For example, the NE 102-a may transmit signaling to the UE 104-a via a downlink communications link 202, which may be an example of a communications link as described with reference to FIG. 1. In some other examples, the UE 104-a may transmit signaling to the NE 102-a via an uplink communications link 204, which may be an example of a communications link as described with reference to FIG. 1. The signaling between the UE 104-a and the NE 102-a may include control signaling and/or data transmissions.

In some examples, the NE 102-a and the UE 104 may in the wireless communications system 200 may support a bandwidth range (e.g., 100 MHz or beyond, the radio channel (depending on the environment/deployment). The bandwidth range may include one or more RBs, as shown in the resource diagram 206. The NE 102-a and/or the UE 104-a may transmit signaling over the bandwidth, where the signaling may experience changes in quality across the bandwidth. The quality may be measured as a signal-to-interference-plus-noise ratio (SINR). The NE 102-a and/or the UE 104-a may compensate for the variations in SINR by selecting an MCS value that is adapted to the average signal quality over the assigned bandwidth. However, the NE 102-a may configure a single MCS value for a TB for a downlink resource assignment or an uplink resource grant. Configuring a single MCS value for a TB does not account for the fluctuations in signal quality over the assigned bandwidth for the TB, leading to inefficient resource allocation. For example, if the NE 102-a and/or the UE 104-a communicate using relatively narrow beams (e.g., less than a threshold beam width), then there may be reduced flexibility to assign frequency ranges to maximize signal quality for a channel (e.g., RB range 1 to UE1 with an SINR that is greater than a threshold value, RB range 2 to UE2 with an SINR that is greater than a threshold value).

To provide for more efficient resource allocation, a NE 102-a may configure multiple MCSs for a single TB dynamically (e.g., using DCI). In some examples, the NE 102-a may transmit a resource assignment 208 to a UE 104-b. For example, the NE 102-a may transmit the resource assignment 208 in dynamic control signaling, such as DCI. Additionally, or alternatively, the NE 102-a may transmit the resource assignment 208 periodically or semi-persistently in RRC signaling and/or a MAC-CE. The resource assignment 208 may indicate one or more time-frequency resources allocated for a transmission 210. The time-frequency resources may include RBs and/or time intervals allocated for the transmission 210, where the transmission 210 may be a downlink transmission from the NE 102-a to the UE 104-a or an uplink transmission from the UE 104-a to the NE 102-a. In some examples, the NE 102-a may include an indication of multiple MCS values (e.g., levels) for a single TB in the transmission 210. For example, the NE 102-a may configure multiple MCS values for a TB in the transmission 210 using the resource assignment 208. The resource assignment 208 may also include an indication of which MCS values applies to respective frequency resources (e.g., RB ranges). In some cases, the NE 102-a may configure multiple RB ranges in control signaling (e.g., in the resource assignment 208 or in RRC signaling prior to the resource assignment 208). The granularity for indicating an RB range is at least one of RB, RBG size, P, the number configured for PRB bundling, or a configured number of RBs.

In some cases, the resource assignment 208 includes one MCS value per set of frequency resources (e.g., per RB range). For example, the resource assignment 208 may include respective MCS values (e.g., including 5 bits) for each set of frequency resources. In some other examples, the resource assignment 208 includes an MCS value that indicates a starting or initial set of frequency resources (e.g., 5 bits) and one or more additional MCS values that indicate an offset from the initial value (e.g., 2 or 3 bits each). The NE 102-a may signal the RB range using the resource assignment 208. For example, the resource assignment 208 may indicate a frequency resource allocation for each RB range, where an order of the RB range in a set of configured RB ranges is associated with a corresponding MCS index. Example frequency resource allocations include, but are not limited to, bitmap-based with RBG granularity (e.g., downlink resource allocation type 0, uplink resource allocation type 0), start index and/or length indication with RB granularity (e.g., downlink resource allocation type 0, uplink resource allocation type 0), and/or a comb-based indication (e.g., uplink resource allocation type 2). For example, RBs indicated by a first RB range are associated with a first MCS value (e.g., an index corresponding to an MCS value in a list of possible MCS values), RBs indicated by a second RB range that are associated with the second MCS value. For comb-based or interlace-based frequency resources, one MCS value applies to a comb-based resource assignment, (a first MCS value applies to RBs 1, 11, 21 and a second MCS value applies to RBs 2, 12, 22, etc.).

In some other cases, the resource assignment 208 includes a bitmap that indicates the MCS values for different sets of frequency resources. For example, the bitmap may indicate two or more different MCS values, where each bit represents an RB group (e.g., a fixed RB group or RB range). For each block (e.g., group, range) of 8 RBs, one bit or field in the resource assignment 208 (e.g., the bitmap) indicates whether a respective first, second, third, etc., MCS value applies to RBs in the block. The RB ranges may be defined or configured (e.g., in RRC signaling), such that RB range 1=PRB 1-50, RB range 2=PRB 51-100, etc. In some examples, a first MCS value is associated with RB range 1, a second MCS value is associated with RB range 2, etc., where the first MCS value and the second MCS value are different.

In some examples, the resource assignment 208 may indicate multiple RB and/or RBG indices, where a first signaled RB and/or RBG index indicates the start of a first RB range, and a second signaled RB and/or RBG index indicates the start of a second RB range. The second signaled RB and/or RBG index indicates that the first RB range terminates at the second signaled RB and/or RBG index minus 1 (e.g., including that RB and/or RBG) or earlier. In some cases, the first RB range starts at RB and/or RBG index 0 (e.g., without being indicated explicitly) and ends at the first signaled RB and/or RBG index minus 1 (e.g., including that RB). In some other cases, the last RB range starts at the last signaled RB and/or RBG index and ends at the highest RB and/or RBG index that can be scheduled by the DCI format (e.g., or

$${N}_{{BWP}_{i}}^{s i z e}$$

for bandwidth part i, or N_{RBG}).

The resource assignment 208 may include a configurable number of MCS values and FDRA fields, where each FDRA field is associated with an MCS value. Each FDRA field being associated with an MCS value provides for a relatively high level of flexibility (e.g., greater than a threshold flexibility or granularity) to adapt the MCS value to individual RBs and their SINRs.

The UE 104-a and/or the NE 102-a may map coded bits to RBs using the MCS values. For example, the UE 104-a and/or the NE 102-a may map coded bits corresponding to a CBG to RBs that are assigned same MCS values. A CBG may include one or more CBs, which is described in further detail with respect to FIG. 3. If there are two CBGs and two RB ranges each with a corresponding MCS value, then all bits corresponding to a first CBG are mapped to a first RB range using the first MCS and all bits corresponding to a second CBG are mapped to a second RB range using the second MCS. If the UE 104-a and/or the NE 102-a is unable to map coded bits of a CBG to RBs assigned to same MCS values (e.g., due to CBG size and resources in the RB ranges), then the UE 104-a and/or the NE 102-a may map as many bits as possible corresponding to a CBG to an RB range.

In some examples, at 212, the UE 104-a may map CBs to frequency resources for transmission based on a TBS for the transmission 210. Once the UE 104-a detects the resource assignment 208 with the multiple MCS values for a single TB, the UE 104-a may determine a TBS for the transmission 210. In some cases, the UE 104-a is configured to detect a new DCI including the resource assignment 208. Additionally, or alternatively, the UE 104-a is configured to detect the presence of additional fields in DCI. The resource assignment 208 may include an indication of MCS values that apply to one or more RB ranges. The UE 104-a determines the TBS from the MCS values and the RBs. For example, the UE 104-a may determine a resulting TBS by adding up partial TBSs for each RB range. That is, the UE 104-a may determine partial TBSs by looking up MCS values from a list using a corresponding scheduled number of RBs (e.g., from a FDRA table). In some other examples, the UE 104-a may determine a partial TBSs through an intermediate step of determining a number of information bits N_{info} for each RB range. The number of information bits N_{info} for an RB range can be determined from a corresponding MCS value, a corresponding number of multiple input-multiple output (MIMO) layers (e.g., if applicable), and/or a corresponding number of scheduled RBs. A partial TBS can then be determined from the number of information bits N_{info} based on a table or a formula depending on the size of N_{info}. For example, the UE 104-a may determine the TBS using a number of information bits (e.g., N_{info}) offered by the resource allocation, determined by N_{info}=N_{RE}*R*Qₘ*v, where N_{RE} is a number of allocated resource elements, R is a code rate, Qₘ is a modulation order, and v is a number of MIMO layers. The UE 104-a may add up the partial TBSs to obtain an intermediate TBS value, TBS′. The UE 104-a may determine a final TBS as a TBS closest (e.g., next higher, next lower) to TBS' that can be obtained if using a single MCS for all RBs. Whether the UE 104-a selects a next higher or next lower TBS may be defined or configured (e.g., by the NE 102-a) at the UE 104-a.

In some other cases, the UE 104-a may select the TBS from a list (e.g., a table) or determine the TBS from a formula based on a minimum MCS value of the MCS values. For example, the UE 104-a may determine which MCS value of the multiple configured MCS values is the lowest. The UE 104-a may use the lowest MCS value to determine the corresponding TBS from the list or from a formula.

The UE 104-a may map CB and/or CBGs to RBs according to a frequency-first approach or according to a time-first approach. For example, in a frequency-first approach, the UE 104-a may map CBs and/or CBGs sequentially across RBs in the frequency domain before moving to the next time slot. In some other examples, in a time-first approach, the UE 104-a may map CBs and/or CBGs sequentially across time slots for a given RB before moving to the next RB in frequency. In some cases, an MCS code point or RB group code point indicates that a single (e.g., first) MCS value is applied throughout a scheduled RB range, where the RB range may be defined via the resource assignment 208 and/or via additional signaling (e.g., RRC signaling).

In some cases, once the UE 104-a maps the CBs to frequency resources, the UE 104-a may transmit the transmission 210 via the uplink communications link 204. Additionally, or alternatively, the UE 104-a may receive the transmission 210 via the downlink communications link 202. In some examples, the NE 102-a may also map the CBs to frequency resources and may transmit or receive the transmission 210, accordingly.

FIG. 3 illustrates an example transmission diagram 300 in accordance with aspects of the present disclosure. In some examples, the transmission diagram 300 implements aspects of the wireless communications system 100 and the wireless communications system 200. For example, the transmission diagram 300 may be implemented by a UE and/or a NE, which may be examples of a NE 102 and a UE 104 as described with reference to FIGS. 1 and 2. In some examples, the NE may employ multiple MCS values for a TB to a UE for the UE to apply to an uplink or downlink transmission. The UE and/or the NE may use the MCS values to map CBs to a TB 302.

In some cases, a NE and/or a UE may transmit a TB 302 with one or more CRC bits 304. The CRC bits 304 may be used for error detection and correction purposes, providing for a receiving device to verify the integrity of the received data. The CRC bits 304 include one or more additional bits appended to data that enable the detection of transmission errors. To transmit the TB 302, the NE and/or the UE may map one or more CBs of the TB 302 to frequency resources. CBs are smaller units of data derived from the TB, which may be independently encoded and decoded. In some cases, the TB 302 may be divided into multiple CBs, including CB₀ through CB_{c-1} to facilitate efficient processing and error management. The CBs may be further grouped into CBGs, including CBG₀ through CBG_{g-1}, where each CBG may include one or more CBs. For example, a TB 302 may be split into 12 CBs, which may then be organized into 6 CBGs, with each CBG including 2 CBs. The NE and/or UE may map these CBs or CBGs to the frequency resources using the assigned MCS values. For example, if two MCS values are assigned for different frequency ranges, the first 4 CBs or first 2 CBGs may be mapped to the frequency resources associated with the first MCS value, while the remaining 8 CBs or last 4 CBGs may be mapped to the frequency resources that are associated with the second MCS value. The flexible mapping approach may provide for more efficient use of the available spectrum by adapting the MCS value to the channel conditions of different frequency ranges (e.g., RBs) within a same transmission (e.g., TB). In some cases, the NE and/or the UE may generate CBGs, such that the CBs in a same CBG use a same MCS value. If MCS values for multiple sets of frequency resources (e.g., RB ranges) are identical, then one or more CBs and/or CBGs for those ranges are not aligned.

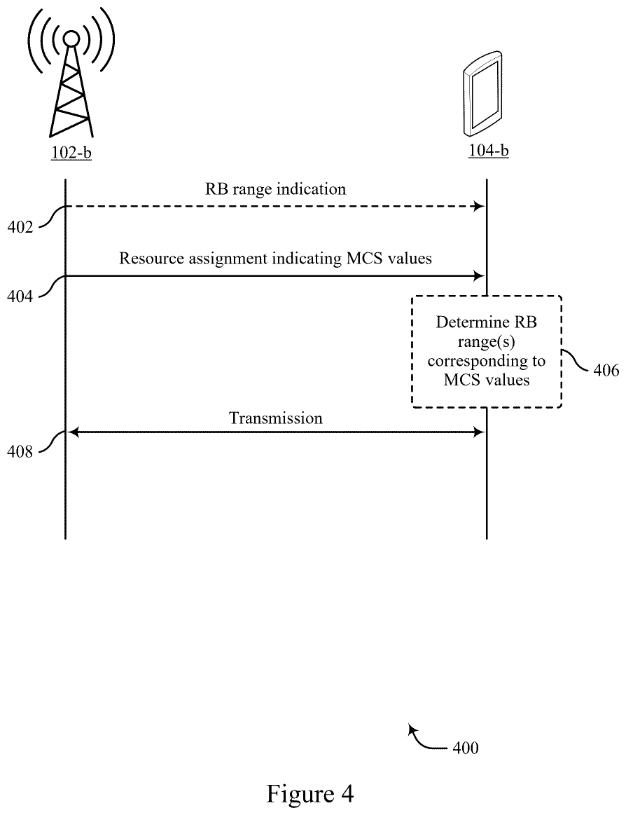

FIG. 4 illustrates an example signaling diagram 400 in accordance with aspects of the present disclosure. In some examples, the signaling diagram 400 may implement aspects of the wireless communications system 100, the wireless communications system 200, and the transmission diagram 300. For example, the signaling diagram 400 may include a NE 102-b and a UE 104-b, which may be examples of a NE 102 and a UE 104 as described with reference to FIGS. 1 and 2. The signaling diagram 400 may illustrate an example of a NE 102-b configuring multiple MCS values for a transmission, such that there are multiple MCS values for a TB. Alternative examples of the following may be implemented, where some processes are performed in a different order than described or are not performed. In some cases, processes may include additional features not mentioned below, or further processes may be added.

In some examples, the NE 102-b transmits signaling that indicates sets of frequency resources. For example, at 402, the NE 102-b transmits an RB range indication to the UE 104-b. The RB range indication may be sent via RRC signaling and indicates a list of RB ranges and/or multiple RB ranges for which the NE 102-b and/or the UE 104-b may apply multiple MCS values.

At 404, the NE 102-b transmits a resource assignment to the UE 104-b. The resource assignment may include one or more frequency resources allocated for a transmission (e.g., a transmission including a TB) and indicates multiple MCS values for each TB. The NE 102-b and/or the UE 104-b may apply the multiple MCS values to respective sets of frequency resources allocated for the transmission. In some cases, the resource assignment may be transmitted as DCI. The respective sets of frequency resources may include respective RB ranges, where one or more RBs in the respective RB ranges are non-overlapping. The resource assignment may include, but is not limited to, indices corresponding to initial RBs in the respective RB ranges and a numerical quantity of consecutive RBs in the respective RB ranges, a bitmap that indicates an MCS value per set of frequency resources, MCS values per set of frequency resources with a starting index and length, the MCS value per the comb-based or interlace-based set of frequency resources, or a bitmap indicating one or more first sets of frequency resources associated with a first MCS value and one or more second sets of frequency resources associated with a second MCS value.

At 406, the UE 104-b determines one or more RB ranges (e.g., or other sets of frequency resources) corresponding to the MCS values based on the received resource assignment. For example, the UE 104-b may determine to apply a first MCS value for a first RB range and a second MCS value for a second RB range, where the first and second RB ranges are allocated for a transmission of a single TB.

At 408, a transmission occurs between the NE 102-b and the UE 104-b based on the MCS values corresponding to the respective sets of frequency resources. The transmission may including transmitting or receiving coded bits of a CBG using the respective sets of frequency resources and corresponding respective MCS values.

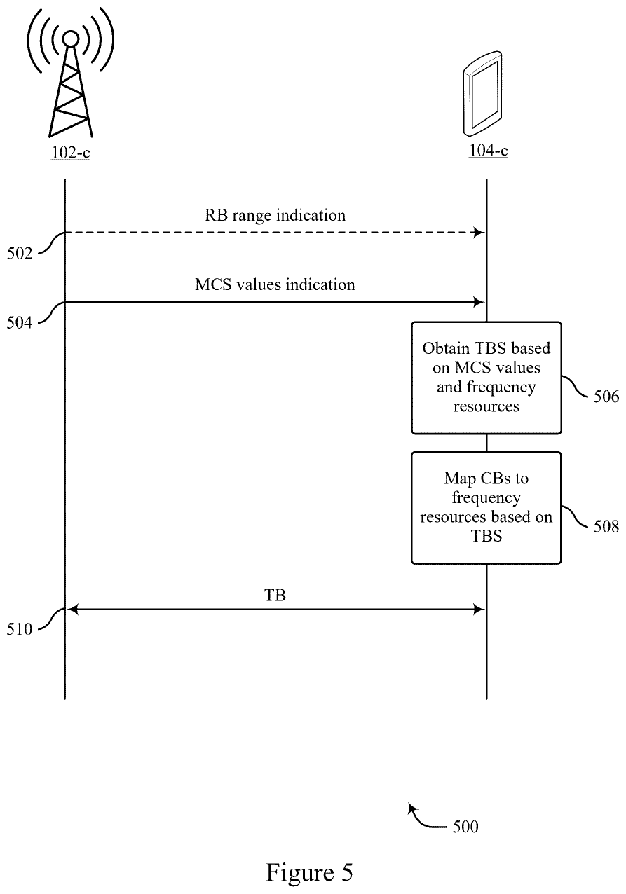

FIG. 5 illustrates an example signaling diagram 500 in accordance with aspects of the present disclosure. In some examples, the signaling diagram 500 may implement aspects of the wireless communications system 100, the wireless communications system 200, the transmission diagram 300, and the signaling diagram 400. For example, the signaling diagram 500 may include a NE 102-c and a UE 104-c, which may be examples of a NE 102 and a UE 104 as described with reference to FIGS. 1, 2, and 3. The signaling diagram 500 may illustrate an example of a UE 104-c obtaining a TBS for mapping CBs to frequency resources based on a NE 102-c configuring multiple MCS values for a transmission, such that there are multiple MCS values for a TB. Alternative examples of the following may be implemented, where some processes are performed in a different order than described or are not performed. In some cases, processes may include additional features not mentioned below, or further processes may be added.

In some examples, the NE 102-c transmits signaling that indicates sets of frequency resources. For example, at 502, the NE 102-c transmits an RB range indication to the UE 104-c. The RB range indication may be sent via RRC signaling. The RB range indication may include a list of RB ranges or another indication of the multiple RB ranges. Additionally, or alternatively, the RB range indication may include an indication that respective RB ranges are associated with multiple MCS values. One or more RBs in the respective RB ranges may be non-overlapping.

At 504, the NE 102-c transmits signaling that indicates MCS values to the UE 104-c. The signaling may include DCI that indicates respective sets of frequency resources allocated for the TB. The respective sets of frequency resources may include the RB ranges from the range indication at 502. The signaling may include indices corresponding to initial RBs in the respective RB ranges and a numerical quantity (e.g., number, amount) of consecutive RBs in the respective RB ranges.

At 506, the UE 104-c obtains a size of the TB (e.g., a TBS) based on the MCS values and the respective sets of frequency resources. To obtain the size of the TB, the UE 104-c may obtain an aggregate of a partial sizes of the TB based on the MCS values and the respective sets of frequency resources. For example, the UE 104-a may obtain the aggregate of the partial sizes of the TB from a look up table or using a formula. Each partial size of the TB is based on a respective MCS value and a respective set of frequency resources. The UE 104-c may select the size of the TB (e.g., from a list) based on the aggregate of the partial sizes of the TB. Additionally, or alternatively, the UE 104-c may select the size of the TB from a list based on a minimum MCS value of the MCS values. In some examples, the UE 104-c may determine a partial TBSs through an intermediate step of determining a number of information bits N_{info} for each RB range. The number of information bits N_{info} for an RB range can be determined from a corresponding MCS value, a corresponding number of MIMO layers (e.g., if applicable), and/or a corresponding number of scheduled RBs. A partial TBS can then be determined from the number of information bits N_{info} based on a table or a formula depending on the size of N_{info}.

At 508, the UE 104-c maps one or more CBs to the respective sets of frequency resources for transmission or reception of the TB based on the size of the TB. To map the one or more CBs to the respective sets of frequency resources, the UE 104-c may assign respective CBs of the one or more CBs to CBGs. In some cases, the respective CBs in a CBG have a same MCS value.

At 510, a TB transmission occurs between the NE 102-c and the UE 104-c based on the MCS values corresponding to the respective sets of frequency resources. The transmission may include transmitting or receiving coded bits of a CBG using the respective sets of frequency resources and corresponding respective MCS values of the plurality of MCS values.

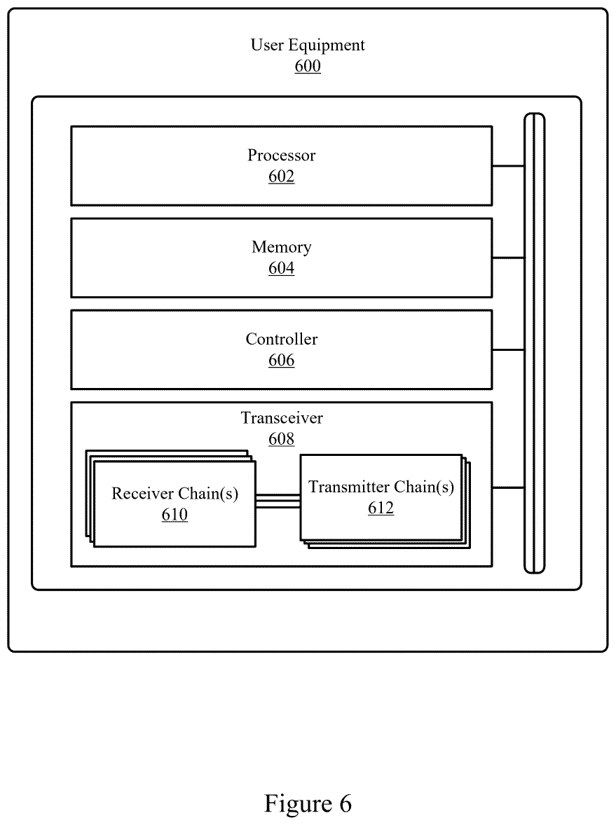

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for receiving signaling that indicates a set of MCS values associated with respective sets of frequency resources allocated for a TB, obtaining a size of the TB based on the set of MCS values and the respective sets of frequency resources, and mapping one or more CBs to the respective sets of frequency resources for transmission or reception of the TB based on the size of the TB.

Additionally, the UE 600 may be configured to support any one or combination of obtaining an aggregate of a set of partial sizes of the TB, where each partial size of the set of partial size is based on a respective MCS value of the set of MCS values and the respective sets of frequency resources, and selecting the size of the TB based on the aggregate of the set of partial sizes of the TB. Additionally, or alternatively, the UE 600 may be configured to support selecting the size of the TB from a list based on a minimum MCS value of the set of MCS values. Additionally, or alternatively, the UE 600 may be configured to support assigning respective CBs of the one or more CBs to CBGs, where the respective CBs in a CBG of the CBGs are associated with a same MCS value of the set of MCS values.

Additionally, or alternatively, the UE 600 may be configured to support the signaling including DCI that indicates the respective sets of frequency resources allocated for the TB. Additionally, or alternatively, the UE 600 may be configured to support the respective sets of frequency resources including respective RB ranges, and where one or more RBs in the respective RB ranges are non-overlapping. Additionally, or alternatively, the UE 600 may be configured to support receiving RRC signaling that indicates a set of RB ranges including the respective RB ranges and that indicates the respective RB ranges are associated with the set of MCS values. Additionally, or alternatively, the UE 600 may be configured to support the signaling including indices corresponding to initial RBs in the respective RB ranges and a numerical quantity of consecutive RBs in the respective RB ranges. Additionally, or alternatively, the UE 600 may be configured to support transmitting or receiving, based on mapping the one or more CBs to the respective sets of frequency resources, coded bits of a CBG using the respective sets of frequency resources and corresponding respective MCS values of the set of MCS values.

Additionally, or alternatively, the UE 600 may support at least one memory (e.g., the memory 604) and at least one processor (e.g., the processor 602) coupled with the at least one memory and configured to cause the UE 600 to receive signaling that indicates a set of MCS values associated with respective sets of frequency resources allocated for a TB, obtain a size of the TB based on the set of MCS values and the respective sets of frequency resources, and map one or more CBs to the respective sets of frequency resources for transmission or reception of the TB based on the size of the TB.

Additionally, the UE 600 may be configured to support any one or combination of to obtain an aggregate of a set of partial sizes of the TB, where each partial size of the set of partial sizes is based on a respective MCS value of the set of MCS values and the respective sets of frequency resources and select the size of the TB based on the aggregate of the set of partial sizes of the TB. Additionally, or alternatively, the UE 600 may be configured to support to select the size of the TB from a list based on a minimum MCS value of the set of MCS values. Additionally, or alternatively, the UE 600 may be configured to support to assign respective CBs of the one or more CBs to CBGs, where the respective CBs in a CBG of the CBGs are associated with a same MCS value of the set of MCS values.

Additionally, or alternatively, the UE 600 may be configured to support the signaling including DCI that indicates the respective sets of frequency resources allocated for the TB. Additionally, or alternatively, the UE 600 may be configured to support the respective sets of frequency resources including respective RB ranges, and where one or more RBs in the respective RB ranges are non-overlapping. Additionally, or alternatively, the UE 600 may be configured to support to receive RRC signaling that indicates a set of RB ranges including the respective RB ranges and that indicates the respective RB ranges are associated with the set of MCS values. Additionally, or alternatively, the UE 600 may be configured to support the signaling including indices corresponding to initial RBs in the respective RB ranges and a numerical quantity of consecutive RBs in the respective RB ranges. Additionally, or alternatively, the UE 600 may be configured to support to transmit or to receive, based on mapping the one or more CBs to the respective sets of frequency resources, coded bits of a CBG using the respective sets of frequency resources and corresponding respective MCS values of the set of MCS values.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) (e.g., QPSK) or QAM. The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

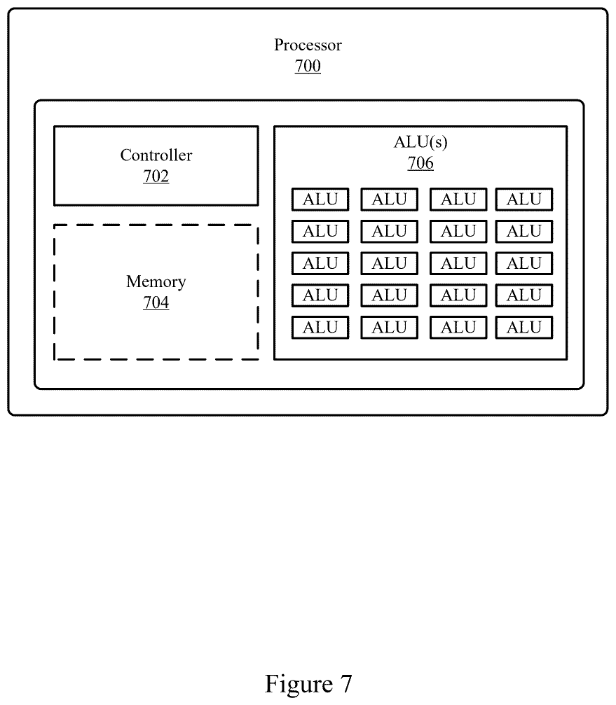

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to receive signaling that indicates a set of MCS values associated with respective sets of frequency resources allocated for a TB, obtain a size of the TB based on the set of MCS values and the respective sets of frequency resources, and map one or more CBs to the respective sets of frequency resources for transmission or reception of the TB based on the size of the TB.

Additionally, the processor 700 may be configured to support any one or combination of to obtain an aggregate of a set of partial sizes of the TB, where each partial size of the set of partial sizes is based on a respective MCS value of the set of MCS values and the respective sets of frequency resources and select the size of the TB based on the aggregate of the set of partial sizes of the TB. Additionally, or alternatively, the processor 700 may be configured to support to select the size of the TB from a list based on a minimum MCS value of the set of MCS values. Additionally, or alternatively, the processor 700 may be configured to support to assign respective CBs of the one or more CBs to CBGs, where the respective CBs in a CBG of the CBGs are associated with a same MCS value of the set of MCS values.

Additionally, or alternatively, the processor 700 may be configured to support the signaling including DCI that indicates the respective sets of frequency resources allocated for the TB. Additionally, or alternatively, the processor 700 may be configured to support the respective sets of frequency resources including respective RB ranges, where one or more RBs in the respective RB ranges are non-overlapping. Additionally, or alternatively, the processor 700 may be configured to support to receive RRC signaling that indicates a set of RB ranges including the respective RB ranges and that indicates the respective RB ranges are associated with the set of MCS values. Additionally, or alternatively, the processor 700 may be configured to support the signaling including indices corresponding to initial RBs in the respective RB ranges and a numerical quantity of consecutive RBs in the respective RB ranges. Additionally, or alternatively, the processor 700 may be configured to support to transmit or receive, based on mapping the one or more CBs to the respective sets of frequency resources, coded bits of a CBG using the respective sets of frequency resources and corresponding respective MCS values of the set of MCS values.

The processor 700 may be configured to or operable to support at least one controller (e.g., the controller 702) coupled with at least one memory (e.g., the memory 704) and configured to cause the processor to transmit signaling that indicates a set of MCS values associated with respective sets of frequency resources allocated for a TB, where a size of the TB is based on the set of MCS values and the respective sets of frequency resources, and transmit or receive, on the respective sets of frequency resources, one or more CBs of the TB based on the size of the TB.

Additionally, the processor 700 may be configured to support any one or combination of to transmit or receive respective CBs of the one or more CBs in CBGs, where the respective CBs in a CBG of the CBGs are associated with a same MCS value of the set of MCS values. Additionally, or alternatively, the processor 700 may be configured to support the signaling including DCI that indicates the respective sets of frequency resources allocated for the TB. Additionally, or alternatively, the processor 700 may be configured to support the respective sets of frequency resources including respective RB ranges, where one or more RBs in the respective RB ranges are non-overlapping. Additionally, or alternatively, the processor 700 may be configured to support to transmit RRC signaling that indicates a set of RB ranges including the respective RB ranges and that indicates the respective RB ranges are associated with the set of MCS values. Additionally, or alternatively, the processor 700 may be configured to support the signaling including indices corresponding to initial RBs in the respective RB ranges and a numerical quantity of consecutive RBs in the respective RB ranges. Additionally, or alternatively, the processor 700 may be configured to support to transmit or receive coded bits of a CBG using the respective sets of frequency resources and corresponding respective MCS values of the set of MCS values.

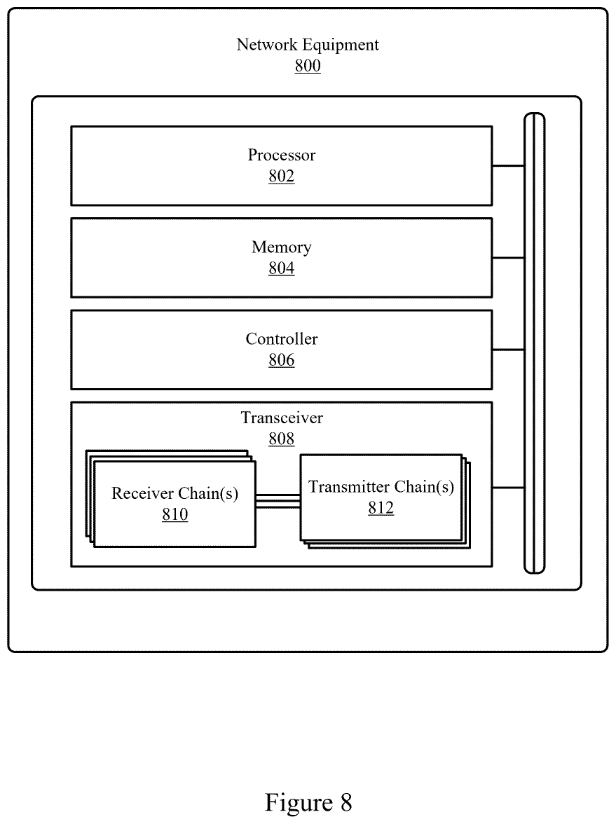

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to or operable to support a means for transmitting signaling that indicates a set of MCS values associated with respective sets of frequency resources allocated for a TB, where a size of the TB is based on the set of MCS values and the respective sets of frequency resources, and transmitting or receiving, on the respective sets of frequency resources, one or more CBs of the TB based on the size of the TB.

Additionally, the NE 800 may be configured to support any one or combination of transmitting or receiving respective CBs of the one or more CBs in CBGs, where the respective CBs in a CBG of the CBGs are associated with a same MCS value of the set of MCS values. Additionally, or alternatively, the NE 800 may be configured to support the signaling including DCI that indicates the respective sets of frequency resources allocated for the TB. Additionally, or alternatively, the NE 800 may be configured to support the respective sets of frequency resources including respective RB ranges, and where one or more RBs in the respective RB ranges are non-overlapping. Additionally, or alternatively, the NE 800 may be configured to support transmitting RRC signaling that indicates a set of RB ranges including the respective RB ranges and that indicates the respective RB ranges are associated with the set of MCS values. Additionally, or alternatively, the NE 800 may be configured to support the signaling including indices corresponding to initial RBs in the respective RB ranges and a numerical quantity of consecutive RBs in the respective RB ranges. Additionally, or alternatively, the NE 800 may be configured to support transmitting or receiving coded bits of a CBG using the respective sets of frequency resources and corresponding respective MCS values of the set of MCS values.

Additionally, or alternatively, the NE 800 may support at least one memory (e.g., the memory 804) and at least one processor (e.g., the processor 802) coupled with the at least one memory and configured to cause the NE to transmit signaling that indicates a set of MCS values associated with respective sets of frequency resources allocated for a TB, where a size of the TB is based on the set of MCS values and the respective sets of frequency resources, and transmit or receive, on the respective sets of frequency resources, one or more CBs of the TB based on the size of the TB.

Additionally, the NE 800 may be configured to support any one or combination of to transmit or receive respective CBs of the one or more CBs in CBGs, where the respective CBs in a CBG of the CBGs are associated with a same MCS value of the set of MCS values. Additionally, or alternatively, the NE 800 may be configured to support the signaling including DCI that indicates the respective sets of frequency resources allocated for the TB. Additionally, or alternatively, the NE 800 may be configured to support the respective sets of frequency resources including respective RB ranges, where one or more RBs in the respective RB ranges are non-overlapping. Additionally, or alternatively, the NE 800 may be configured to support to transmit RRC signaling that indicates a set of RB ranges including the respective RB ranges and that indicates the respective RB ranges are associated with the set of MCS values. Additionally, or alternatively, the NE 800 may be configured to support the signaling including indices corresponding to initial RBs in the respective RB ranges and a numerical quantity of consecutive RBs in the respective RB ranges. Additionally, or alternatively, the NE 800 may be configured to support to transmit or receive coded bits of a CBG using the respective sets of frequency resources and corresponding respective MCS values of the set of MCS values.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., an LNA) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

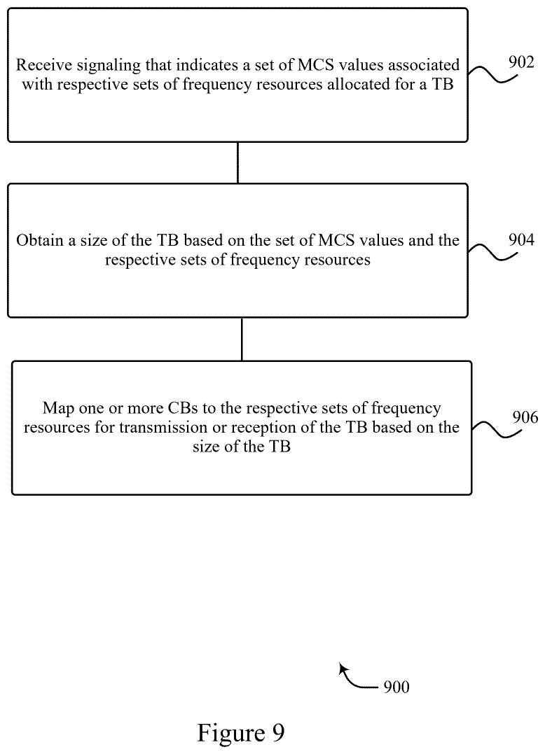

FIG. 9 illustrates a flowchart of a method 900 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 902, the method may include receiving signaling that indicates a set of MCS values associated with respective sets of frequency resources allocated for a TB. The operations of 902 may be performed in accordance with examples as described herein. In some implementations, aspects of the operations of 902 may be performed by a UE as described with reference to FIG. 6.

At 904, the method may include obtaining a size of the TB based on the set of MCS values and the respective sets of frequency resources. The operations of 904 may be performed in accordance with examples as described herein. In some implementations, aspects of the operations of 904 may be performed by a UE as described with reference to FIG. 6.

At 906, the method may include mapping one or more CBs to the respective sets of frequency resources for transmission or reception of the TB based on the size of the TB. The operations of 904 may be performed in accordance with examples as described herein. In some implementations, aspects of the operations of 904 may be performed by a UE as described with reference to FIG. 6.

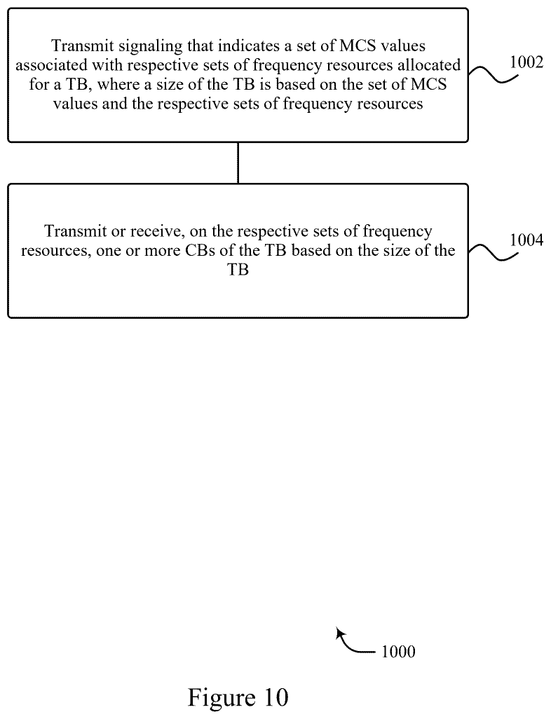

FIG. 10 illustrates a flowchart of a method 1000 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include transmitting signaling that indicates a set of MCS values associated with respective sets of frequency resources allocated for a TB, where a size of the TB is based on the set of MCS values and the respective sets of frequency resources. The operations of 1002 may be performed in accordance with examples as described herein. In some implementations, aspects of the operations of 1002 may be performed by an NE as described with reference to FIG. 8.

At 1004, the method may include transmitting or receiving, on the respective sets of frequency resources, one or more CBs of the TB based on the size of the TB. The operations of 1004 may be performed in accordance with examples as described herein. In some implementations, aspects of the operations of 1004 may be performed by an NE as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive signaling that indicates a plurality of modulation and coding scheme (MCS) values associated with respective sets of frequency resources allocated for a transport block (TB);
obtain a size of the TB based at least in part on the plurality of MCS values and the respective sets of frequency resources; and
map one or more code blocks (CBs) to the respective sets of frequency resources for transmission or reception of the TB based at least in part on the size of the TB.

2. The UE of claim 1, wherein to obtain the size of the TB, the at least one processor is operable to cause the UE to:
obtain an aggregate of a plurality of partial sizes of the TB, wherein each partial size of the plurality of partial sizes is based at least in part on a respective MCS value of the plurality of MCS values and the respective sets of frequency resources; and
select the size of the TB based at least in part on the aggregate of the plurality of partial sizes of the TB.

3. The UE of claim 1, wherein to obtain the size of the TB, the at least one processor is operable to cause the UE to select the size of the TB based at least in part on a minimum MCS value of the plurality of MCS values.

4. The UE of claim 1, wherein to map the one or more CBs to the respective sets of frequency resources, the at least one processor is operable to cause the UE to assign respective CBs of the one or more CBs to code block groups (CBGs), wherein the respective CBs in a CBG of the CBGs are associated with a same MCS value of the plurality of MCS values.

5. The UE of claim 1, wherein the signaling comprises downlink control information (DCI) that indicates the respective sets of frequency resources allocated for the TB.

6. The UE of claim 1, wherein the respective sets of frequency resources comprise respective resource block (RB) ranges, and wherein one or more RBs in the respective RB ranges are non-overlapping.

7. The UE of claim 6, wherein the at least one processor is further operable to cause the UE to receive radio resource control (RRC) signaling that indicates a plurality of RB ranges comprising the respective RB ranges and that indicates the respective RB ranges are associated with the plurality of MCS values.

8. The UE of claim 6, wherein the signaling comprises indices corresponding to initial RBs in the respective RB ranges and a numerical quantity of consecutive RBs in the respective RB ranges.

9. The UE of claim 1, wherein the at least one processor is operable to cause the UE to transmit or receive, based at least in part on mapping the one or more CBs to the respective sets of frequency resources, coded bits of a code block group (CBG) using the respective sets of frequency resources and corresponding respective MCS values of the plurality of MCS values.

10. A method performed by a user equipment (UE), the method comprising:
receiving signaling that indicates a plurality of modulation and coding scheme (MCS) values associated with respective sets of frequency resources allocated for a transport block (TB);
obtaining a size of the TB based at least in part on the plurality of MCS values and the respective sets of frequency resources; and
mapping one or more code blocks (CBs) to the respective sets of frequency resources for transmission or reception of the TB based at least in part on the size of the TB.

11. The method of claim 10, wherein obtaining the size of the TB comprises:
obtaining an aggregate of a plurality of partial sizes of the TB, wherein each partial size of the plurality of partial sizes is based at least in part on a respective MCS value of the plurality of MCS values and the respective sets of frequency resources; and
selecting the size of the TB based at least in part on the aggregate of the plurality of partial sizes of the TB.

12. The method of claim 10, wherein obtaining the size of the TB comprises selecting the size of the TB based at least in part on a minimum MCS value of the plurality of MCS values.

13. A network equipment (NE) for wireless communication, comprising:
at least one memory; and
at least one processor coupled with the at least one memory and operable to cause the NE to:
transmit signaling that indicates a plurality of modulation and coding scheme (MCS) values associated with respective sets of frequency resources allocated for a transport block (TB), wherein a size of the TB is based at least in part on the plurality of MCS values and the respective sets of frequency resources; and
transmit or receive, on the respective sets of frequency resources, one or more code blocks (CBs) of the TB based at least in part on the size of the TB.

14. The NE of claim 13, wherein to transmit or receive the one or more CBs of the TB, the at least one processor is operable to cause the NE to transmit or receive respective CBs of the one or more CBs in code block groups (CBGs), wherein the respective CBs in a CBG of the CBGs are associated with a same MCS value of the plurality of MCS values.

15. The NE of claim 13, wherein the signaling comprises downlink control information (DCI) that indicates the respective sets of frequency resources allocated for the TB.

16. The NE of claim 13, wherein the respective sets of frequency resources comprise respective resource block (RB) ranges, and wherein one or more RBs in the respective RB ranges are non-overlapping.

17. The NE of claim 16, wherein the at least one processor is further operable to cause the NE to transmit radio resource control (RRC) signaling that indicates a plurality of RB ranges comprising the respective RB ranges and that indicates the respective RB ranges are associated with the plurality of MCS values.

18. The NE of claim 16, wherein the signaling comprises indices corresponding to initial RBs in the respective RB ranges and a numerical quantity of consecutive RBs in the respective RB ranges.

19. The NE of claim 13, wherein the at least one processor is operable to cause the NE to transmit or receive coded bits of a code block group (CBG) using the respective sets of frequency resources and corresponding respective MCS values of the plurality of MCS values.

20. A method performed by a network equipment (NE), the method comprising:
transmitting signaling that indicates a plurality of modulation and coding scheme (MCS) values associated with respective sets of frequency resources allocated for a transport block (TB), wherein a size of the TB is based at least in part on the plurality of MCS values and the respective sets of frequency resources; and
transmitting or receiving, on the respective sets of frequency resources, one or more code blocks (CBs) of the TB based at least in part on the size of the TB.
